(19) United States
(12) Patent Application Publication
(10) Pub. No.: US 2007/0143032 A1
(43) Pub. Date: Jun. 21, 2007

(54) Apparatus and method for the detection of a surface reaction, especially for cleaning of an arbitrary two-dimensional surface or three-dimensional body

(75) Inventors: Fokko Pieter Wieringa, RE Elst (NL); Norbertus Benedictus Koster, KT Delft (NL); Roland Edward Van Vliet, VN Aalsmeer (NL); Marco Wedowski, Aalen (DE); Nadyeh Shariloo, Aalen (DE); Thomas Stein, Oberkochen (DE)

Correspondence Address: Charles N.J. Ruggiero;Ohlandt, Greeley, Ruggiero & Perle, L.L.P., One Landmark Square, 10th Floor, Stamford, CO, 06901-2682, US

(73) Assignee: CARL ZEISS SMT AG

(21) Appl. No.: 11/522,783

(22) Filed: Sep. 15, 2006

Related U.S. Application Data
(60) Provisional application No. 60/717,481, filed on Sep. 15, 2005.

(51) Int. Cl. G01N 31/00

(52) U.S. Cl. 702/24

(57) ABSTRACT

There is provided an apparatus that includes a film that undergoes a chemical reaction when exposed to a species. The chemical reaction causes an alteration of a physical property of the film as an indicator of the species.

### CROSS-REFERENCE TO RELATED APPLICATION

This application claims the benefit and priority of U.S. provisional application 60/717,481 filed Sep. 15, 2005 in the US-PTO. The content of U.S. provisional application 60/717,481 is incorporated herein in its entirety.

### BACKGROUND OF THE INVENTION

1. Field of the Invention

The invention relates to an apparatus for the detection of a surface reaction especially for indication of a cleaning and/or surface defects of an arbitrary two dimensional surface and/or three-dimensional body and a method of such a detection, especially with a high spatial resolution and a high sensitivity. Furthermore the invention provides also for the usage of the apparatus for cleaning an arbitrary two-dimensional surface and/or three-dimensional body with a high spatial resolution and sensitivity. Furthermore, the invention provides for a lithographic apparatus with a test-surface, especially for the detection of noxious gases in a lithographic apparatus.

2. Description of the Related Art

For many cleaning processes such as plasma cleaning, cleaning with active oxygen, UV-cleaning in air, cleaning in the fluid phase and cleaning of surfaces with ultrasounds, it is desirable to obtain information if the cleaning of the surface is sufficient or not.

To evaluate, if a cleaning process is sufficient a sensitive tool is needed. Particularly it is desirable to probe the homogeneity of a cleaning of an arbitrary two-dimensional surface or three-dimensional body by a oxygen radical distribution within a cleaning facility when a plasma cleaning method is used.

A plasma cleaning method is a dry cleaning method that uses ionized low pressure gases such as oxygen which effects e.g. surface oxidation or an inert gas or mixtures of an inert gas and oxygen e.g. a mixture of argon and oxygen as a plasma source

Especially emerging technologies like nano-technology, Immersion-Lithography, DUV-Lithography (e.g. with wavelengths of 193 nm and 157 nm) as well as EUV-Lithography (e.g. with wavelengths of 13 nm) require surfaces where neither particulate nor chemical e.g. layer formed contamination is present. In many cases the surfaces to be cleaned in such technologies, especially surfaces of optical or mechanical components for lithography with wavelengths ≦193 nm have complex shapes, which complicates their cleanability. Such surfaces are therefore cleaned preferably with contactless ultra fine cleaning technologies like UV-ozone, plasma, low pressure as well as atmospheric or supercritical CO₂-cleaning process. It is desirable to evaluate the cleaning efficiency of such a cleaning.

Especially for 3-dimensional hollow bodies with openings such as slits, boreholes, blind-holes etc., it is difficult to achieve a homogeneous cleaning efficacy especially inside the hollow body, since some of the aforementioned ultra fine cleaning technologies suffer from a “line of sight” effect. A line of sight effect is caused e.g. by the shadows in the interior of an hollow body with an opening. If one irradiates the interior of a hollow body with e.g. UV-light from an UV light source placed outside the hollow body through an opening only those parts of the interior will be irradiated which receive light through the opening. Parts of the hollow body which lie in the shadow of the opening will not be cleaned. For cleaning the interior of such an hollow body e.g low pressure plasma cleaning methods can be used.

In order to check if the cleaning e.g. by the plasma cleaning method is sufficient, it is necessary to monitor or at least indicate the cleaning efficiency with a high sensitivity. Especially if a hollow body is cleaned it is advantageous if the cleaning in the interior of the hollow body can be monitored.

According to the state of the art, the cleaning efficiency was determined e.g. by contact angle measurements before and after cleaning. This method is commonly used as a cheap indicator, while expensive XPS measurements are applied in cases where extreme precision is required.

For some delicate structures e.g. EUV-mirrors neither contact angle measurements nor XPS measurements are allowed due to the surface deterioration they cause.

Another possibility to determine cleaning efficiency is the usage of so called witness-plates. The witness-plates accompany the structure to be cleaned. The witness plate is modeled as a worst case e.g. being the dirtiest object within the process and/or placed at the position that is expected to be the most difficult to clean. In a hollow body e.g. a position that is expected to be cleaned most difficult are the so called shaded areas, which can not be directly observed from outside. In order to determine if this area is cleaned sufficiently, one can evaluate if a so called “witness plate” is treated sufficiently. If this is the case then there could be a strong assumption, that also the surface to be cleaned in the difficult areas are treated sufficiently.

In addition to Ultra High Vacuum or Ultra Clean Vacuum processes also on other fields of surface science an apparatus and a method is desirable, which gives information about cleaning efficiency or surface defects.

Further cleaning processes are for example plasma sterilization in medicine. Regarding the detection of surface damages the registration of scratches or other surface damages especially in industry or in space technology is desirable.

In the medical field medical plasma sterilizers form a new cleaning technology offering quick sterilization without thermal damage. Validation of such a cleaning process is highly desirable. The validation should be a stable and repeatable process that is capable to detect whether the sterilization process has reached all areas of the component to be sterilized. In case of a hollow body with an opening these are particularly the corners within the hollow body in the shaded areas. Neither with contact angle nor XPS or electron microscopy as in the state of the art it is possible to evaluate, if a sterilization process as described above was sufficient.

Another problem in the medical field are surface contaminations with prions. Prions are smaller than viruses and cannot be detected by traditional microbiological methods. It is known that prions could be destroyed by oxidative plasma. Nevertheless if an oxidative plasma is used it has to be validated if the cleaning with respect to the prions where sufficient.

Still another field in which an evaluation is desirable is the evaluation of surfaces in the industrial area. For example it is desirable to register scratches or surface damages, especially of a protective layer applied e.g. onto the surface of a wafer.

A further field in which the indication and quantification of surface reactions is desirable is the field of space technology.

The drawbacks of methods to evaluate a surface according to the state of the art are as follows:

The XPS-measurements are very precise but very costly and only revealing information about a tiny spot on the surface of a sample could be gathered. Furthermore XPS-measurements allow only for an offline analysis and no real-time measurement is possible e.g. during a plasma cleaning process.

Contact angle measurements are not very precise and only revealing information about a drop-sized spot on the surface of a sample is gathered. Only offline analysis is possible and no real-time measurements are possible e.g. during the plasma cleaning process.

From U.S. Pat. No. 4,740,383 a method for checking the degree of plasma treatment is known. According to U.S. Pat. No. 4,740,383 a color change of an organic e.g. a carbon hydrogen based active material is induced by a plasma. In total six different organic materials are described.

A problem of the method described in U.S. Pat. No. 4,740,383 is that it is difficult to distinguish between the color of the most superficial layer and the color of the bulk of the layer. Furthermore a limited dynamic range is given, because the read-out is restricted to the reflection mode only. Furthermore the problem arises, that since organic materials are used. Organic materials can decompose when illuminated with UV-light. The decomposed material pollutes the vacuum and eventually the surfaces to be cleaned.

From EP 1 205 743 an “Indicator for Plasma Sterilization” has been made known. The indication takes place by a change from colorless to a color tone. The active layer is a mixture of several components. Several different active materials are described, all being carbon-hydrogen based. For these carbon-hydrogen based material the problems as described above such as decomposition applies.

With the lithographic apparatus known from U.S. Pat. No. 6,980,281 a in situ monitoring of the atmosphere in the lithographic apparatus is not possible.

From U.S. Pat. No. 6,980,281 B2 it is known, that due to the decreasing size of integrated circuits the wavelength of the light used in lithographic equipment are wavelength in the UV range or even shorter. This leads to an increased risk of light induced chemical reactions at the surface of the optical elements in the beam path towards the substrate. In particular, gas molecules from the atmosphere that surrounds the optical elements may give rise to reaction products on these surfaces, such as oxides or hydrocarbon deposits, or material may even be desorbed from these surfaces. These reaction products can adversely affect imaging of patterns on to the substrate, due to changes in reflectivity or transmissivity of the optical elements. To minimize such problems, the atmosphere near the surface of the optical elements has to be carefully controlled to ensure that potentially noxious gases are not present in excessive amounts.

According to U.S. Pat. No. 6,980,281 B2 it is therefore necessary to detect whether more than an acceptable amount of such gases is present in the atmosphere around the optical elements and to adjust parameters that affect the atmosphere if this is the case. For the detection of some gases, and for the detection of some extreme situations, it suffices to monitor the partial gas pressure. However, for other gases monitoring partial gas pressure is not sufficient. This is the case for example when the partial pressure for a gas species is excessively low in comparison with overall pressure around the optical elements. Similarly, it may be impossible to monitor subtle deviations from a desired state, if the deviations have no measurable short term effects on the optical elements but affect the optical elements in the long term.

According to U.S. Pat. No. 6,980,281 a lithographic apparatus with a test surface is provided. The test surface is of a material that is sensitive to chemical alterations that may affect the optical elements under influence of radiation from the beam.

According to U.S. Pat. No. 6,980,281 the test surface is exposed to the beam. After exposing the test surface to the beam, and typically after exposing the test surface many times, so that a considerable exposure duration of, say, at least ten hours or more preferably at least a hundred hours is accumulated, the test surface is analyzed for reaction products that indicate the presence of undesirable amounts of gases. If this is detected the parameters of the apparatus that affect the composition of the atmosphere near the surface of optical components can be adjusted.

For the analysis the test surface must be removed from the lithographic apparatus. The analysis is then performed outside the lithographic apparatus

### SUMMARY OF THE INVENTION

It is therefore an object of the invention to provide a method and apparatus for surface analysis, which avoids the disadvantages of the state of the art.

Furthermore, a lithographic apparatus should be provided which allows for a permanent, especially in-situ monitoring of the atmosphere in the lithographic apparatus

Furthermore, the invention should provide for a method and apparatus for the detection of a surface reaction as an indication especially for a cleaning and/or surface defects of an arbitrary 2-dimensional surface or 3-dimensional body with a high sensitivity. In a further aspect of the invention the spatial distribution of e.g. a plasma induced chemically reactive species should be visualized directly as a measure for the cleaning.

Furthermore the method and apparatus should allow for an easy quantification, especially of the cleaning efficiency. Also it should be possible to obtain an optical and an electrical signal which is a measure for the cleaning efficiency, especially for the cleaning efficiency in an lithographic apparatus in real time, e.g. during a plasma process or as a monitoring of the atmosphere in a lithographic apparatus e.g. during the exposure process.

The object of the invention is solved by an apparatus for detection of a surface reaction as an indication of a cleaning and/or surface defects of an arbitrary 2-dimensional surface or 3-dimensional body The apparatus comprises a surface onto which one or more chemical components are deposited forming a film on the surface. The components of the surface are chemically sensitive for a reactive species e.g. of a plasma process by undergoing a specific chemical reaction, wherein the specific chemical reaction causes an alteration of at least a physical property of the film.

Furthermore the object of the invention is solved by a method of detection of a surface reaction as an indication of a cleaning and/or surface defects of an arbitrary 2-dimensional or 3-dimensional body of arbitrary shape. According to the inventive method the reactive species comes into contact with a film deposited on a surface having at least a component being chemically sensitive to the reactive species, wherein the component undergoes a chemical reaction whereby at least a physical property of the film is altered by the chemical reaction and wherein said alteration is a measure for the cleaning and/or the surface defects.

Furthermore the object of the invention regarding a lithographic apparatus is achieved in that the lithographic apparatus, which comprises a beam processing system for providing a beam of radiation along a beam path to a substrate includes a test surface covered by a film comprising one ore more chemical components. The components are chemically sensitive for a species to be detected by undergoing a specific chemical reaction, which causes an alteration of a least a physical property of said film. This alteration in the physical properties can be directly read out and fed e.g. to a control unit, which monitors and/or controls e.g. the atmosphere in the lithographic apparatus. The species to be detected in the lithographic apparatus can be e.g. O₂; O-radical, organic and/or inorganic compounds containing sulfur. Species should be understood in this application as to comprise all sorts of molecules, atoms, ions, radicals and chemical compounds. The wording species is not restricted to the aforementioned specific compounds. With the inventive lithographic apparatus an in-situ monitoring of the atmosphere in the lithographic apparatus is possible under operation conditions, i.e. when a light sensitive substrate is illuminated e.g. in a wafer processing step.

With the inventive process it is also possible that the test surface or a plurality of test surfaces are introduced in the lithographic apparatus, e.g. after the lithographic apparatus has been cleaned, e.g. by a plasma cleaning. The test surfaces are exposed after the cleaning in the atmosphere (residual gas) of the lithographic apparatus and is removed later on therefrom. The change of the physical properties of the film after the test surface has been removed from the lithographic apparatus is a measure for the cleaning efficiency.

The test surfaces can be situated within the lithographic apparatus in every position. In a preferred embodiment the test surface can be situated in or near one or more optical elements in the lithographic apparatus. The optical elements are situated within the lithographic apparatus in a box. The box can be e.g. a common box for both the illumination system and the projection lens or two separate boxes for the projection system and the illumination system each. The box which is containing the optical elements of the microlithography projection system is normally evacuated to ultra high vaccum conditions. Nevertheless even if the box is evacuated, there exists an atmosphere comprising residual gas within the box. By the test surface according to the application the atmosphere within the box can monitored. An in-situ monitoring is possible. The monitoring can be undertaken in operation of the lithographic apparatus, when the lithographic apparatus is cleaned or after the cleaning has been performed.

In a preferred embodiment of the invention at least two test surfaces are placed e.g. on a rotating plate. One test surface is brought into the box in order to measure the atmosphere within the lithographic apparatus, whereas the other test surface is brought in a position outside of the box. In this position outside of the box the other test surface can e.g. be evaluated e.g. with regard to the atmosphere inside the box.

In a most preferred embodiment the film being sensitive for a species, the also so called indicator layer consists not of an organic, but of an inorganic material.

This has the advantage that the film can be produced much easier than for an organic compound and furthermore the inorganic film has a higher UV-stability. Furthermore with a film of an inorganic material it is possible to detect both oxidative and reducing reactions at the surface and the reactions can be distinguished from each other.

Regarding the change of the physical properties of the film deposited onto the surface, not only the optical properties of the inorganic film change due to the chemical reaction of the reactive species at the surface but also or in addition the electrical properties are changed.

Preferably the inorganic compounds which form the films are metals or metal oxides. For oxidative processes the films are formed by metals, e.g. Cu, Ag, Ru, Cr, Rh and for reducing processes the films will be formed by metal oxides, preferable conductive metal oxides such as ITO (Indium Tin Oxide). Mentioning the different materials is not a restriction, but only a preferred embodiment of the invention. In principal all inorganic materials can be used, if they undergo a specific chemical reaction with an alteration of the physical properties e.g. in a plasma used for cleaning or in the atmosphere of a lithographic apparatus.

Especially for the detection of a sufficient cleaning in an oxidative plasma Ag is a very sensitive inorganic material. In an oxidative plasma Ag will be oxidized from Ag to AgO. Ag and AgO have different optical properties. Whereas Ag forms a very good reflector in the UV- VIS- and IR-wavelength region, AgO forms a very strong absorber in the UV-, VIS, and IR wavelength region. If the reduction by hydrogen should be detected Indium-tin-oxide (ITO) is preferred.

Ag can also be used for the test surface of a lithographic apparatus. Such a test surface is preferably used for the detection of O₂ or O-radicals in the atmosphere of the lithographic apparatus during operation.

Generally speaking metals form an oxide, when reacting with oxygen radicals e.g. of the plasma and metal-oxides are reduced when reacting with hydrogen radicals.

In a preferred embodiment an active layer is deposited on an optically transparent substrate, e.g. glass, quartz, sapphire. In principal any transparent substrate e.g. in the UV, VIS and IR wavelength or all wavelength regions can be applied. In such an embodiment both sides of the thin active layer can be optically readout separately, thus providing an extended dynamic range. The dynamic range of the coating surface indicates the low dose range and the dynamic range of the coating/substrate interface indicates the high dose range. The matching point between the both dynamic ranges can be adjusted very precise by altering the thickness of the deposited layer. The read out can be in-situ or after the transparent substrate was exposed to an atmosphere e.g. in an lithographic apparatus.

The dynamic range is defined by light reflected by the different surfaces as well as by the total transmission from one side to another. A difference of the reflection within 0,1% creates an sufficient contrast to determine, e.g., fast processes at the coating surface and slow processes at the coating/substrate interface.

For a well reflecting layer, e.g. a silver layer, reflection mainly takes place in the most superficial region. Only true in-depth penetration during exposure to the plasma process can cause a change in reflectance at the substrate side. Therefore by choosing a larger layer thickness one can produce an easy to use indicator providing a certain “process tolerance window” which is defined by the fact that for a normal process the successfully exposed coating side should be highly absorptive and the substrate side should retain an unchanged reflectance. Violation of the safe process window by an overexposure can then be detected by reflectance loss at the substrate side.

By covering the indicator layer with a material that acts as a model for the surface process to be investigated in an advantageous embodiment, an optical indicator of process efficacy can be produced. Of course it has to be ensured that no spontaneous chemical or photochemical reactions will occur. Contamination can also be considered as a second layer.

With the inventive method and the inventive apparatus the surface of complex 2-or 3-dimensional shapes could be investigated. Especially witness targets which do not necessarily need to be flat shaped can be investigated. Also the investigation of wires, hollow rods, or even more complex 3-dimensional shapes are possible. Furthermore the investigation of the cleaning efficiency of a hollow body with an aperture is possible, especially in the shaded areas.

In a further embodiment the witness object or certain parts of it can be grounded or kept at a positive or negative voltage. This allows discrimination between chemical reactions caused by neutral species e.g. radicals, or charged species e.g. ions and electrons.

If in an even further embodiment the film or the coatings are combined with a fiber optic read out system and/or with a electric wiring. In such a case a real time feedback on reaction progress is possible.

The optical detection can take place within the ultraviolet (UV), visible (VIS) or infrared (IR) range of electromagnetic radiation. If the detection uses the electric properties of the film, e.g. the microwave or HF-energy absorption of tuned circuits then by a surface reaction the resistive characteristics of such circuits will change. The change of the electrical properties by the surface reaction can be used in a lithographic apparatus e.g. for the in-situ detection of O₂ or O-radicals.

If according to the invention an apparatus with a film according to the invention is placed within holders having well defined access slits or holes, information about the geometrical distribution of the reactive species can be gathered. Furthermore the penetrating properties into the slit or hole of various cleaning processes can reproducibly be tested, archived and compared.

According to the invention different films can be deposited on the surface of the inventive apparatus. E.g. a first and a second layer with different materials can be combined. In a preferred embodiment the two different materials are coated in such a way onto a substrate, that a first part of the substrate is coated with a first layer, e.g. a Cu layer and the second part of the substrate is coated with a second layer e.g. a Ag layer. Since both metals react different onto e.g. different environments, different process can be evaluated.

Since the apparatus can be produced in high numbers with high accuracy and be combined with readout systems like densitometers, reflectometers and/or resistance meters, it is possible that with appropriate software easy to use, automated packages quality control programs can be provided, also for a lithographic apparatus.

Furthermore the inventive method offers the possibility to directly visualize the distribution of oxygen radicals and also hydrogen radicals within a plasma chamber or lithographic apparatus, even in shaded areas. Furthermore with a proper camera an observation even in real time of hydrogen or oxygen radicals is possible.

In a further improved embodiment if an active layer with chemical sensitive components is deposited on a isolation substrate e.g. glass, quartz, sapphire, ceramic, plastic, rubber and two or more electrical connections are prepared on the active layer, a current flow can be routed through the active layer. Due to the isolating nature of the substrate, this current flow is mainly determined by electrical properties of the active layer. From the change of the current flow a reactive species could be detected.

By exploiting the commonly known “skin effect” it is possible to distinguish between the electrical properties of the film being chemically sensitive and the electrical properties of the entire film cross section. Such a system is further denoted as DC/HF read out system. The skin effect causes high frequency (HF; frequency >1 MHz) currents to flow only within a superficial layer of the film with a decreasing penetration depth for increasing frequencies. For Direct Current (DC; frequency =0 Hz) however, the entire film cross section contributes to electrical conduction. This can be used to provide an extended dynamic range. The dynamic range of the film surface indicates the low dose range and the dynamic range of the entire active film cross section indicates the high dose range. The matching point between the both dynamic ranges can be adjusted very precise by altering the frequency of the electrical current and/or the thickness of the deposited conductive layer. A coaxial conductor having a well defined characteristic impedance can be used such as a DC/HF read out system, thus allowing real time feedback on reaction progress even within narrow passages. With such a process one can determine the end of a reaction process very precisely.

With the inventive apparatus also time domain reflection measurements are possible. Time domain reflection measurements are known in the state of the art to localize faults in coaxial cables. When performing time domain reflection measurements a short pulse is sent into an impedance-matched cable, which is terminated by an impedance matching component. If across the whole cable length no changes in characteristic impedance occur, no reflections of the input pulse will result. If however a change in characteristic impedance is present along the cable, the input pulse is partly reflected. Reflection amplitude is a measure of impedance mismatch and the time between sending the input pulse and receiving its echo determines the location of the mismatch. If a short pulse is sent into an apparatus with a conductive film on an isolating substrate, then the reactive species will alter the conductivity in those areas where an surface reaction is performed. From the time domain measurements one can conclude in which area the surface reaction has taken place.

With the inventive apparatus and the inventive method it is thus possible to verify how effective surface areas located throughout a plasma process reaction chamber are being treated during the process or after the process has been applied. Furthermore with the inventive apparatus and the inventive method it is possible to distinguish the nature of plasma induced reactions. It can be distinguished between oxidative reactions and reducing reactions. For example Silver will be blackened (i.e. the reflection and transmission are lowered) by exposure to oxygen radicals but will not be altered by hydrogen radicals, whereas Indium Tin Oxide will change from transparent to a darkened state (i.e. the transmission is lowered) by exposure to hydrogen radicals but will not be altered by oxygen radicals.

Furthermore with the inventive apparatus and method it is possible to monitor the progress of the plasma process at certain critical areas while the process takes place. The signals obtained from such a monitoring device can be used for feedback and control purposes.

If different film components are used the influence of a plasma process upon a multitude of different materials by a single exposure to such a process can be measured. In a preferred embodiment the two different components are coated onto different areas of the substrate.

The inventive method and apparatus further also provides for an amplification of minor mechanical scratches or surface damages. To check the removal of contaminations or certain materials e.g. the plasma process can be used as a “photographic developer”. In this application the term “photographic developer” describes a situation in which by a specific chemical reaction e.g. with the plasma silver is oxidized to silver-oxide . Even very small penetrations will become visible, if one uses a “protective layer” on top of the plasma active layer. By using a protective layer on top of the plasma active layer, the plasma will not reach the plasma active layer unless the protective layer is penetrated. With this technique also extremely small scratches become visible due to the photographic development of Ag to AgO by the plasma process.

Even scratches that would be visible only by a SEM-method are amplified such, that they are visible by an ordinary microscope. If e.g. a scratch of 5 nm thickness is a so called critical scratch, then by making the protective layer (the so called second layer) 5 nm thick, the critical scratch will penetrate the protective layer.

When the apparatus is then exposed to a plasma in a plasma chamber the reactive layer will only change its optical features where the scratch penetrates the second layer. If by the plasma process the second layer is removed with a certain removal rate (e.g. if a transparent polymer is used), then after removal of 1 nm of the second layer smaller scratches, e.g. of a depth of 4 nm start to appear. At the location where the protective layer was already penetrated the contrast will increase. By this method extremely small scratches can be made visible. An Example of a material for a critical layer to be investigated is SiO₂.

Furthermore if one uses as a second layer a polymer with stepped thicknesses of e.g. 5 nm, 10 nm, 15 nm and 20 nm then the polymer removal process can be evaluated.

The inventive apparatus and the inventive method furthermore can be used for the detection of the deposition of contamination upon surfaces covered with a bare active layer. Here again the plasma process is used like a “photographic developer”. Contaminated areas are shielded from the plasma. This means that e.g. the optical transmission or reflection in an contaminated area is different from the optical transmission or reflection in an uncontaminated area. Therefore from the different optical properties in the different areas of the surface, one can make contaminations visible.

In even a more preferred embodiment on top of an active layer a multitude of other materials can be applied. The removal of such materials can be detected very sensitive with only one exposure to the removal process.

Also the deposition of material upon an active layer can be detected.

The inventive apparatus can be used for a remote or a real-time read-out. This can be performed either electrical or optical. A covering layer on top of the active layer may be a fluorescent which increases the contrast. Any polymer or organic fluorescent material can be used for this purpose.

If an optical read-out is performed the optical signal is an optimal one if the substrate is transparent. However, a transparent substrate is not absolutely necessary for practicing the invention. If an electrical read-out is performed the electrical signal is an optimal one if the substrate is isolating however, also a conductive substrate can be used for practicing the invention.

Since the test surface of the lithographic apparatus has the same structure as the apparatus for the detection of a surface reaction all advantages described for the apparatus apply for the test surface situated in a lithographic apparatus.

### BRIEF DESCRIPTION OF THE DRAWINGS

The invention is now described with respect to the embodiments and the figures.

The figures show:

FIG. 1A-1B the principle of the invention

FIG. 1C a hollow body to be cleaned with an inventive apparatus

FIG. 2 an embodiment showing the penetration of plasma radicals into an Aluminum block through a slit opening

FIG. 3 Transmission spectra of plasma treated samples

FIG. 4A-4D detection apparatus for the longitudinal detection of a plasma-front

FIG. 5 detection apparatus for oxygen processes.

FIG. 6 lithographic apparatus with a test surface according to the invention

FIG. 7 aperture screen with a test surface

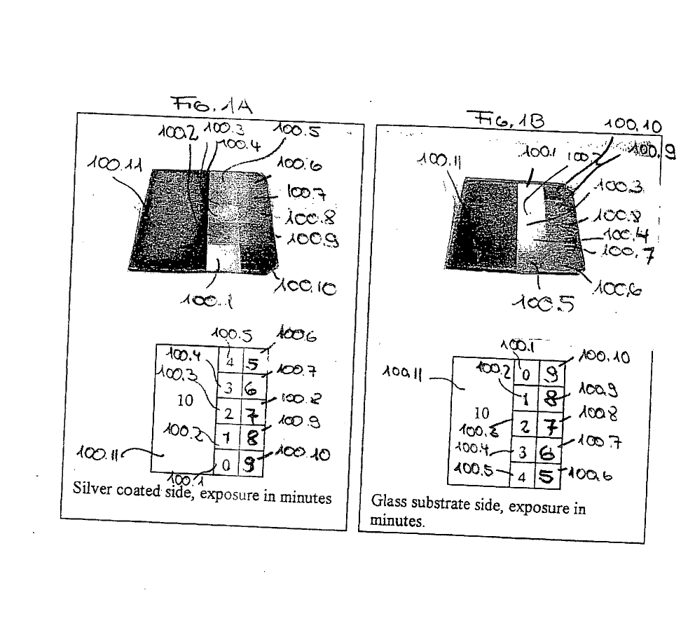

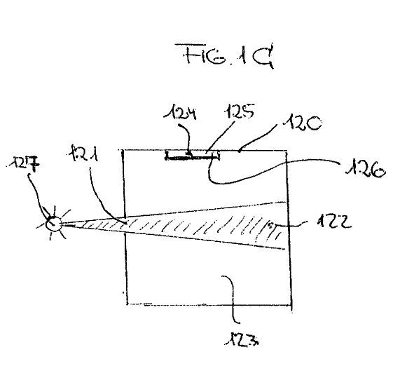

FIG. 1A and 1B show the principle of the inventive apparatus and the test surface of the lithographic apparatus as well as the inventive method. In FIG. 1A and 1B an inventive apparatus or test surface comprising a glass substrate and a 50 mm thick Ag-film deposited on at least one surface of the glass substrate is shown. The Ag-film or Ag-layer coated onto the at least one side of the glass substrate is the active layer. Ag is the chemically sensitive component.

The reactive species in the example shown are the oxygen radicals, which occur in an oxygen/Argon plasma cleaning process. The oxygen radicals will induce an oxidative reaction of elementary silver to silver oxide. Whereas thin silver layers are transparent as is well known for a person skilled in the art the transmission and reflection of Silver Oxide-layers is reduced. This means, that upon exposure with oxygen radicals in a plasma cleaning process the highly transparent silver-layer becomes a dark, non-transparent silver-oxide layer. The transmission and reflection are then a value for the oxygen-content. Therefore such a test surface can be used as an oxygen detector in a lithographic apparatus.

In FIG. 1A the silver coated side of a glass-substrate is shown. Different areas 100.1, 100.2, 100.3, 100.4, 100.5, 100.6, 100.7, 100.8, 100.9, 100.10, 100.11 are plasma cleaned in an oxygen/argon plasma for 0, 1, 2, 3, 4, 5, 6, 7, 8, 9 and 10 minutes. As is clearly seen the darkness of the reactive film or the reactive layer increases when the cleaning time increases. The cleaning time correlates to the exposure time of the silver-layer

In FIG. 1B the glass-substrate-side of the glass-substrate is shown. Different areas 100.1, 100.2, 100.3, 100.4, 100.5, 100.6, 100.7, 100.8, 100.9, 100.10, 100.11 are plasma cleaned in an oxygen/argon plasma for 0, 1, 2, 3, 4, 5, 6, 7, 8, 9 and 10 minutes. As is clearly seen also the darkness on the substrate side increases when the cleaning time increases, but in more moderate way than on a silver coated side shown in FIG. 1A.

The silver coated side of the glass-substrate is a visible indication, for short exposure times, which correlate with low doses of oxygen reacting with the elementary silver of the silver coating, whereas the glass-substrate-side is an indication for long exposure times correlating to a high dose of oxygen reacting with the coating.

By evaluating the darkness, i.e. the reflectance, of the silver coated side and the darkness, i.e. the reflectance of the coating/substrate in the case the glass-substrate side is evaluated, the dynamic range of the inventive method can be fully exploited.

In general if one coats a substrate with an active layer of either metal or metal oxide on a transparent substrate the chemical reaction takes place on the surface of the substrate, which is coated with the active layer. If one determines e.g. as a physical property the optical reflection then the reflection on the coated side will change significantly under exposure by the plasma, whereas on the substrate side there is no detectable difference in reflection. When the active layer is exposed for such a long time, that the substrate comes into sight of the reflected radiation, then the reflection on the substrate side will also change. Therefore the system as shown in FIGS. 1A and 1B has two dynamic ranges with an adjustable gap between the two ranges. The gap is adjusted mainly by the thickness of the active layer.

If the cleaning time which correlates to the darkness of the apparatus is a measure for the cleaning efficiency then by such an apparatus cleaning can be evaluated. Such an apparatus can be placed e.g. inside a hollow body. By monitoring the darkness of the apparatus, one can evaluate the cleaning efficiency even inside a hollow body, e.g. in shaded areas. In FIG. 1c such a hollow body with an inventive apparatus is shown.

In FIG. 1c 120 describes the hollow body and reference number 121 the opening. Light from an outside light source e.g. an UV light source 127 will only illuminate the area denoted with reference number 122. The areas 123 are so called shaded areas according to the invention. In order to clean also such shaded areas one can use a plasma instead of UV light. The plasma will penetrate the whole interior of the hollow body due to diffusion, if one waits long enough. Therefore also these areas are cleaned by a plasma. In order to evaluate the cleaning one can provide the hollow body with one or more inventive apparatus for the detection of the cleaning. The apparatus 124 can be an apparatus according to FIG. 1A or FIG. 1B with a substrate 125 and a reactive film 126, such as a 50 nm Ag-film. From the darkness of the reactive film one can evaluate the cleaning efficiency.

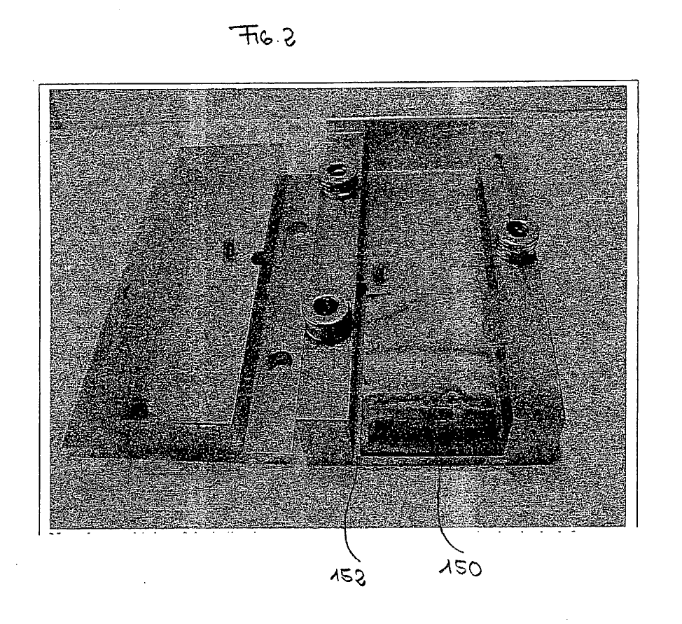

In order to show, that if the plasma source is placed outside an hollow body the plasma has a certain penetration depth and the interior will be filled by the plasma particles only slowly by diffusion FIG. 2 is shown.

In FIG. 2 a silver coated microscope slide 150 consisting of a glass-substrate and a silver film or a silver coating as a surface sensitive layer was inserted into an aluminum block consisting of two pieces. Between the two pieces a variable slit 152 was left open, so that oxygen molecules of a plasma could be penetrating into the interior of the aluminum block.

The slit height could be altered stepwise from 1 mm to 6 mm.

By evaluating the darkness of the glass substrate with the silver coating thereon one could evaluate how deep oxygen out of the argon/oxygen plasma diffused through the slit into the interior of the aluminum block.

In FIG. 2 an aluminum block containing a microscope slide is shown. The microscope slide 150 was exposed through the slit 152 having a height of 6 mm for 10 minutes to a plasma process. After 6 minutes as shown in FIG. 2 the block was opened and as can be clearly seen the darkness of the silver layer on the substrate decreases from the slit side to the interior of the aluminum block. From the darkness of the silver layer on the glass substrate the penetration depth could be obtained.

Different penetration depths of the oxygen of the argon/oxygen plasma could be found depending on the placement of the aluminum block in the plasma chamber and—by keeping it in one place—for different plasma parameter settings. If the aluminum block was placed in the plasma chamber near the plasma source a higher penetration depth was found then for samples which where placed away from the source in the plasma chamber.

Optimum settings for penetration can be easily found by exposing samples to different process parameters.

As is apparent from FIG. 2 even relatively unskilled persons can quantify the penetration depth and the cleaning efficiency e.g. through a slit in the interior of a arbitrary space for a plasma cleaning process. In the example shown this is an oxygen/argon plasma cleaning process. Such a cleaning can be evaluated as shown by evaluating the darkness of a silver coated glass substrate.

Instead of monitoring a plasma process by reading out the behavior of the oxygen of the argon/oxygen plasma, one could use glass substrates with an ITO coating. With an ITO coating not the distribution of the oxygen radicals are visualized but distribution of the hydrogen radicals.

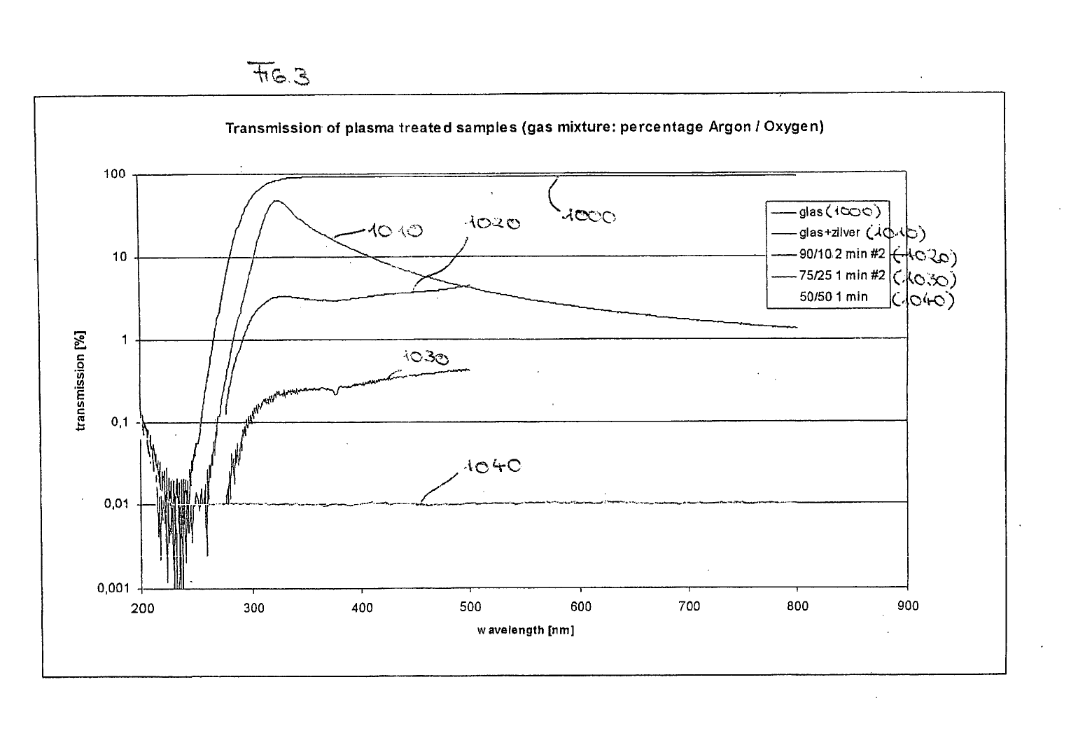

In FIG. 3 the transmission curve 1000 for an uncoated glass substrate, the transmission curve 1010 for an unexposed silver coated substrate, the transmission curve 1020 for an exposed silver coated substrate in a plasma process for two minutes and the transmission curve 1030 for one minute is shown. The gas mixture of the argon/oxygen plasma was for the sample which was exposed for 2 minutes 90 weight-% argon and 10 weight-% oxygen whereas for the sample, which was exposed for 1 minute 75 weight-% argon and 25 weight-% oxygen. Furthermore a transmission curve 1040 is shown for a exposed silver coated substrate, which was exposed for 1 minute to a plasma consisting a 50 weight-% oxygen and 50 weight-% argon. The transmission is in the whole wavelength region very low.

As can be seen from FIG. 3, for transmission measurements and optimum sensitivity is found around a wavelength of 325 nm. The dynamic range is from 0,1% to 100% transmission, which means it comprises 3 decades. Furthermore FIG. 3 shows that a plasma containing 50 weight-% O₂ and even a plasma containing 25 weight-% O₂ does much more cleaning in 1 minute than a plasma with 10 weight-% O₂ in 2 minutes. The device allows therefore an easy comparison between different plasma having e.g. a different O₂-content.

The embodiment shown in FIG. 1a-c and 2 are embodiments of the invention, in which the physical property which is changed by the surface chemistry for example in an argon/oxygen plasma is an optical property of the sensitive coating.

The change of these optical properties could also be evaluated online e.g. by a reflectometer or a densitometer, e.g. via an optical fiber.

Furthermore with a proper camera also a real-time observation especially of large areas is possible. This can be used also if a test surface in a lithographic apparatus is monitored in situ.

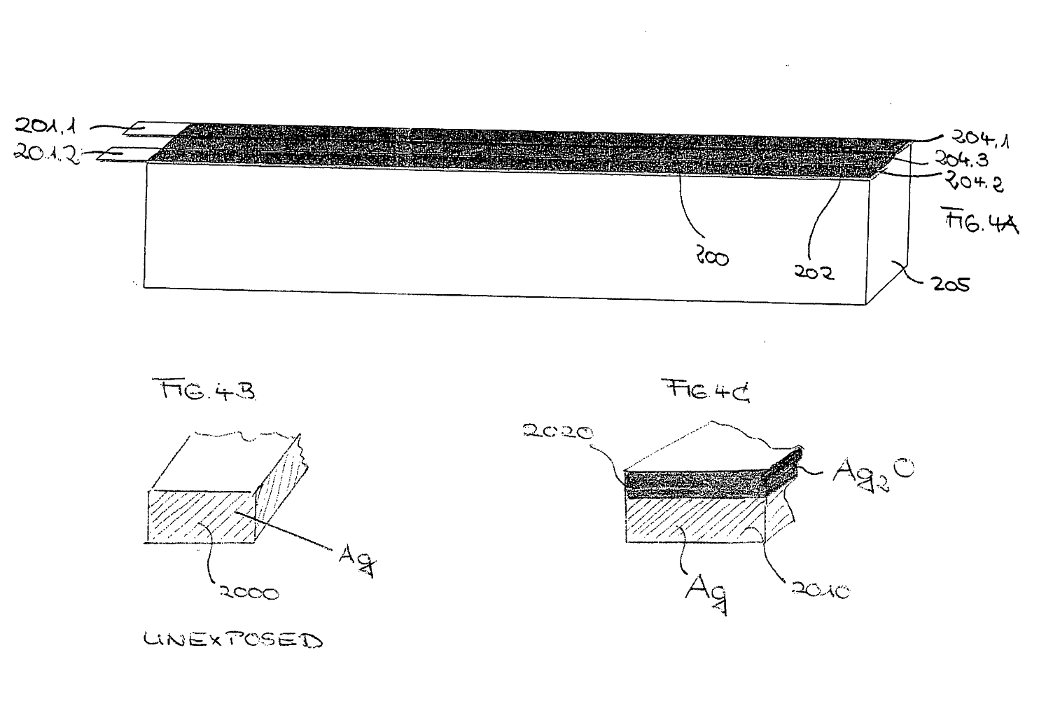

In the embodiments shown in FIG. 4A-D and 5 the electrical properties of the deposited film are used for detection of a surface reaction. This detection method could also be used for the in situ monitoring of the atmosphere in a lithographic apparatus with an evaluation of the change of the electrical properties of the test surface. As an alternative to monitoring the electrical properties of the film, one can monitor an optical property of the film. A film 200 deposited onto a surface 202 consists of one ore more electrical conductive components such as a metal (e.g., silver) or indium-tin oxide (ITO) being chemically sensitive to the species to be detected. A chemical reaction on the surface of film 200, when exposed to the species, causes an alteration of the electrical properties of film 200, for example, the exposure changes the resistivity or the conductivity of film 200.

If a metallic silver or Indium-Tin-Oxide film is deposited on an isolation substrate 205 (e.g. glass, quartz, sapphire, ceramic, plastic, rubber) as shown in FIG. 4A and two or more electrical connection 201.1, 201.2 are prepared on the film layer then current flow can be routed through conductive films, i.e., films 204.1 and 204.2, which are situated on a surface 202 of a substrate 205. A region 204.3 between films 204.1 and 204.2, is not conductive. Due to the isolating properties of substrate 205 the current flow is determined by the electric properties of films 204.1 and 204.2.

FIG. 4B shows an example of a film that is a possible embodiment of films 204.1 and 204.2, being made of silver, i.e., Ag. When the film is not being exposed to a species, a whole cross section 2000 of the film conducts an electric current with a low resistance.

FIG. 4C shows the if film of FIG. 4B being exposed to an atmosphere that contains the species. Ag reacts with oxide or O-radicals that are embodied in the atmosphere to yield a layer 2020 of Ag₂O. In such a case a smaller cross section of Ag 2010, as compared to whole cross-section 2000, conducts the electric current and the resistance increases. If the electrical properties of the film is altered, then this alteration can be measured to provide an indication of the species and a quantity of the species. Based on the quantity of the alteration of the physical property, e.g. the resistance, one can determine a quantity of the species to which the film is exposed. For example, one can determine a quantity of oxide molecules in the atmosphere.

FIG. 4D shows an alternative embodiment in which a surface of the substrate was totally coated with a conductive film, but thereafter, a reactive plasma etched away an area 206.1. The etching nevertheless, left a conductive film in area 206.2. Therefore, there is no current flow through area 206.1, but there is current flow between film 204.1 and film 204.2, through area 206.2. The level of current flow, or the resistivity, are indicative of the size of area 206.2 that has not been etched away, which is therefore indicative of the size of area 206.1 that has been etched away.

As described before with regard to FIG. 4A it is not necessary that the conductive layer is etched away fully in order to detect surface reaction. Even if the conductive material is only oxidized from Ag to Ag₂O the electrical properties such as resistance change and therefore such a surface reaction can be detected.

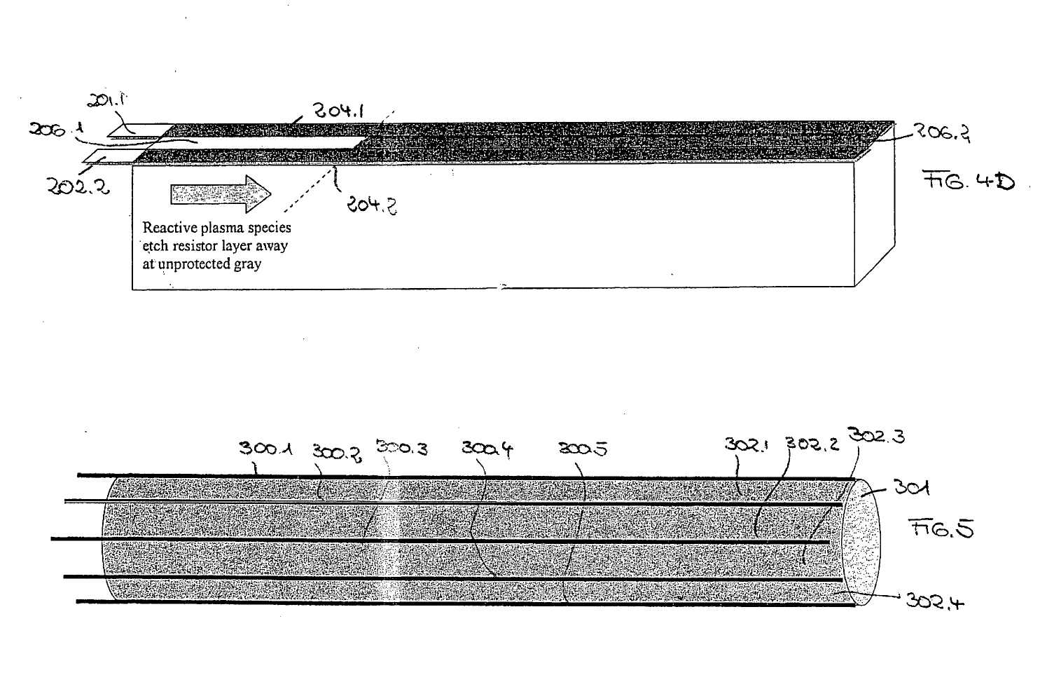

In FIG. 5 a detection apparatus with a plurality of conductive wires 300.1, 300.2, 300.3, 300.4, 300.5 applied onto for example a rod-shaped isolator 301 which maybe flexible is shown. On an isolating glass rod 301 a conducting material such as ITO or silver is applied. Onto this layer a plasma sensitive (e.g. carbon) resistor film is applied and than partly protected by a chemical inert and electrically isolating layer (e.g. SiO₂) in the areas of the conductive wires 300.1, 300.2, 300.2, 300.4, 300.5. The area 302.1 302.2, 302.3, 302.4 between the conductive wires 300.1, 300.2, 300.3, 300.4, 300.5 is not covered by the inert layer. Therefore these areas are exposed to a reactive plasma species which causes a local change of the electrical properties as described before in the description of FIG. 4B and 4C. The change in resistivity can be readout.

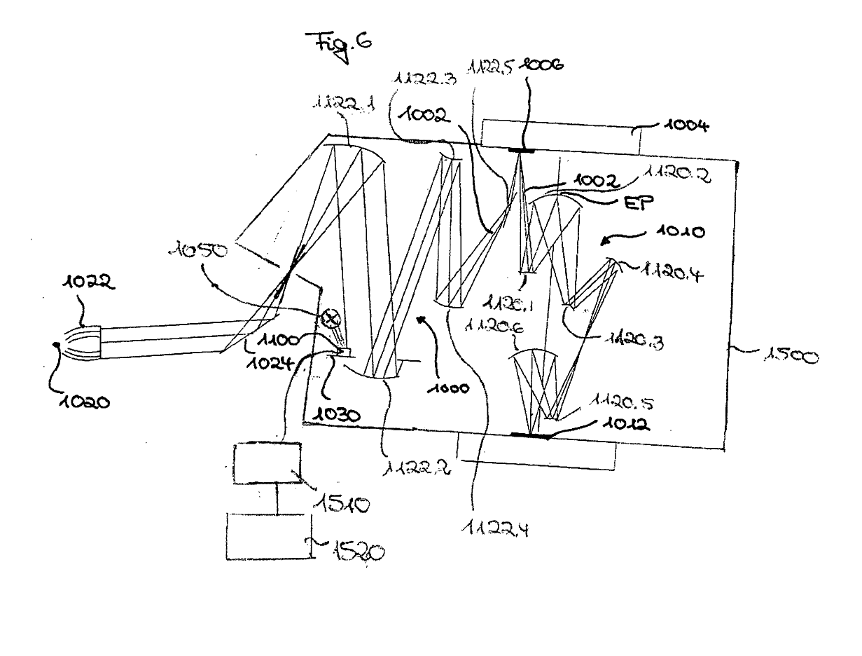

In FIG. 6a lithographic apparatus schematically is depicted. In the embodiment shown the lithographic apparatus is a lithographic apparatus using EUV-radiation of a wavelength of e.g. 13,5 nm as shown e.g. in U.S. Pat. No. 6,438,199 or U.S. Pat. No. 6,198,793 the content of which is enclosed herein. The application should not be restricted to a lithographic apparatus with EUV-radiation, but also cover lithographic apparatus for UV radiation e.g. with wavelength of 193 nm. The apparatus comprises: an illumination system 1000 for providing a projection beam 1002 of radiation (e.g. UV or EUV radiation); a first support structure (e.g. a mask table) 1004 for supporting a reticle (e.g. a mask) 1006. In the plane in which the mask is situated the illumination system 1000 illuminates an area, which is in most cases a so called arc shaped field. The mask is projected by catoptric, catadioptric or dioptric projection lens 1010 onto a light sensitive substrate 1012 situated on a substrate table (e.g. a wafer table 1012).

In the embodiment depicted, the apparatus is of a reflective type (e.g. employing a reflective mask and a reflective illumination system 1000 and a reflective projection lens). Alternatively, the lithographic apparatus may be of a transmissive type (e.g. employing a transmissive mask). Either one of the illumination system 1000 or the projection lens 1010 individually or the illumination system 1000 and the projection system 1010 together will be referred to as “beam processing system”.

The illumination system 1000 receives a beam of radiation from a radiation source 1020. The source and the lithographic apparatus may be separate entities, for example when the source is a plasma discharge source. In such cases, the source is not considered to form part of the lithographic apparatus and the radiation beam is generally passed from the source 1020 to the illumination system 1000 with the aid of a radiation collector 1022 comprising for example suitable collecting mirrors and/or a spectral purity filter 1024. In other cases the source may be integral part of the apparatus, for example when the source is a mercury lamp for UV radiation. The source 1020 and the illumination system 1000, may be referred to as a radiation system. In the embodiment depicted the FIG. 6 the illumination system 1010 as well as the projection objective 1010 is situated in a box 1500. Within the box 1500 exists an atmosphere (comprising residual gas). An apparatus, i.e., a test surface 1100, can be used to detect a species in an atmosphere within box 1500, especially to detect contaminations. The contaminations can be detected in-situ, continuously, e.g. by an electric or optical detector, i.e., detector 1510. Detector 1510 detects an alteration of a physical property of a film on test surface 1100, when the film is exposed to the species. Detector 1510 further measures a quantity of the alteration of the physical property of the film. A processor 1520 determines, based on the quantity of the alteration, a quantity of the species to which the film is exposed.

Test surface 1100, detector 1510 and processor 1520 can also be used, in-situ and continuously, to detect and determine a quantity of a species in an atmosphere of a lithographic apparatus.

Alternatively test surface 1100 can be introduced into the atmosphere of the lithographic apparatus after a cleaning e.g. with a cleaning gas or a plasma is performed. In order to evaluate the cleaning efficiency the test surface is removed from the lithographic apparatus after e.g. 15 minutes of exposure in the cleaned atmosphere. From the change of the physical properties of the test surface one can conclude the contaminations after a cleaning step.

The illumination system 1000 may comprise an adjuster that adjusts the angular intensity distribution of the beam. The illumination system 1000 provides a conditioned beam of radiation, referred to as the projection beam 1002, having a desired uniformity and intensity distribution and intensity distribution in its cross-section.

The projection beam 1002 is incident on a patterning device, illustrated in form of the mask 1006, which is held on a mask table 1004. Being reflected by the mask 1006, the projection beam 1002 passes through the lens 1010, which focuses the beam onto a light sensitive substrate 1012. The illumination system 1000 shown contains an operational aperture blade or aperture screen 1030 for setting the illumination pattern in the exit pupil of the illumination system 1000. The exit pupil of the illumination system 1000 is coincident with the entrance pupil EP of the projection lens 1010. Furthermore, in FIG. 6 the test surface 1100 according to the invention onto which one or more chemical components deposited forming a film is depicted. The components are chemically sensitive for a reactive species to be detected. In FIG. 6 the test surface 1100 is situated on an aperture screen 1030 in the lithographic apparatus. This arrangement is only an example without restriction. If e.g. the cleaning efficiency is detected more than one test surface can be brought into the box 1500 of the lithographic apparatus, preferably near the optical elements, e.g. the mirrors 1120.1, 1120.2, 1120.3, 1120.4, 1120.5, 1120.6 of the lens 1010 or the mirrors 1122.1, 1122.2, 1122.3, 1122.4, 1122.5 of the illumination system 1000. If an optical read out system is used to detect the change of the optical properties of the film of the test surface a separate light source 1050, which emits light with a wavelength different, in particular with a longer wavelength than the light of the light source 1020 is used.

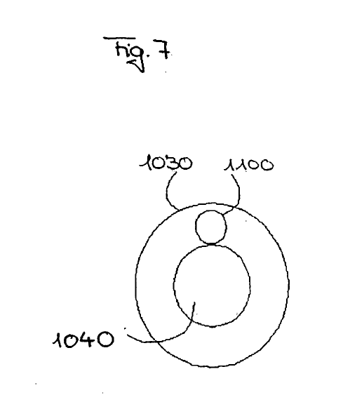

In FIG. 7 the aperture screen 1030 or aperture blade is shown in more detail. FIG. 7 shows an aperture blade 1030 with an aperture 1040 in the center thereof. Aperture blade 1030 blocks out part of projection beam 1002 from the beam path in the lithographic apparatus in or near a pupil plane. Projection beam only passes through the aperture 1040 of the aperture shade.

A test surface 1100 with a film coated thereon according to the invention is mounted on the aperture blade, facing a direction of incidence of projection beam 1002 on aperture blade 1030 for detection of processes that may deteriorate the optical properties of the mirrors of the optical elements. A high intensity short wavelength projection beam 1002, such as a EUV beam can cause reactions to occur at the surface of the mirrors. For example, in the presence of oxygen in the atmosphere at the surface of the mirrors projection beam may induce oxidation. Similarly, hydrocarbons present in the atmosphere may become attached to the mirrors. Metals present in the atmosphere may contaminate the mirrors. Material may also be desorbed from the mirrors.

Test surface 1100 with the chemically reactive components deposited thereon to form a film is used to detect whether these effects occur during operation. Since the alteration of the film deposited on the surface can be read out via an optical or electrical signal, the atmosphere can be monitored in situ, i.e. during operation of the lithographic apparatus. It is not necessary to remove the test surface from the lithographic apparatus in order to evaluate the test surface as e.g. in the case of U.S. Pat. No. 6,980,281.

By the inventive method and the inventive apparatus a species on a surface can be visualized directly. Furthermore, by reading out transmission or reflectivity or other optical or electrical properties also quantification is possible. Furthermore, optical and electrical signals could be obtained in real time for example during a plasma cleaning process. The technique can be used e.g. to monitor cleaning efficiency of a plasma cleaning process or for detecting surface damages or the removal of a polymer on a substrate. Furthermore, a lithographic system is provided with a test surface allowing for in situ monitoring the atmosphere in the lithographic apparatus.

1. An apparatus comprising:
a film that undergoes a chemical reaction when exposed to a species,
wherein said chemical reaction causes an alteration of a physical property of said film as an indicator of said species.

2. The apparatus of claim 1, wherein said physical property is selected from the group consisting of an optical transmission, an optical reflection and an electric conductivity.

3. The apparatus of claim 1, wherein said film comprises a material selected from the group consisting of a metal and a metal-oxide.

4. The apparatus of claim 1, wherein the film comprises a material selected from the group consisting of Ag, Cu, Ru, Cr and Rh.

5. The apparatus of claim 1, wherein said film comprises a material selected from the group consisting of indium-tin-oxide, copper oxide, ruthenium oxide, chromium oxide, cadmium tin oxide, aluminium zinc oxide and tungsten oxide.

6. (canceled)

7. The apparatus of claim 1, further comprising:
a transparent substrate,
wherein said film is deposited on said transparent substrate.

8. The apparatus of claim 7, wherein said transparent substrate comprises a material selected from the group consisting of calcium fluoride, glass, quartz-glass, sapphire, glass ceramic and a polymer.

9. The apparatus of claim 1, further comprising an indicator layer deposited onto said film.

10. The apparatus of claim 9, wherein said indicator layer comprises a material selected from the group consisting of a polymer and a fluorescent.

11. The apparatus of claim 1, wherein said film is an electrically conductive film.

12. The apparatus of claim 11, further comprising an isolating substrate, wherein said electrically conductive film is deposited on said isolating substrate.

13. The apparatus of claim 12, wherein said isolating substrate comprises a material selected from the group consisting of glass, quartz-glass, sapphire, glass ceramic, plastic, rubber and calcium fluoride.

14. The apparatus of claim 11, wherein said electrically conductive film has at least two electrical connections.

15. (canceled)

16. A method comprising:
exposing a film to a species,
wherein said film undergoes a chemical reaction when exposed to said species, and
wherein said chemical reaction causes an alteration of a physical property of said film as an indicator of said species.

17. The method of claim 16, wherein said physical property is selected from the group consisting of an optical transmission, an optical reflection and an electrical property.

18. The method of claim 16,
wherein said physical property is selected from the group consisting of an optical transmission and an optical reflection, and
wherein said alteration affects a wavelength region selected from the group consisting of ultraviolet, visible and infrared.

19. The method of claim 16, wherein said physical property is a resistivity characteristic of a circuit, and said resistivity characteristic is monitored by a microwave-radiation or a radio-frequency-radiation.

20. The method of claims 16,
wherein said physical property is an electrical current flow through said film, and
wherein said electrical current flow is altered when said species comes into contact with said film.

21. The method of claim 16, wherein said physical property is an electrical behavior of said film when an electrical current is flowing through said film.

22. The method of claim 16, wherein said species is embodied in an atmosphere within a hollow body.

23. The method of claim 22, wherein said film is on an apparatus situated inside said hollow body.

24. The apparatus of claim 1,
wherein said species is embodied in an atmosphere within a 3-dimensional body, and
wherein said indicator is evaluated to determine a cleaning efficiency of said atmosphere.

25. The apparatus of claim 24, wherein said 2-dimensional surface or 3-dimensional body comprises an optical component.

26. The apparatus of claim 24, wherein said 2-dimensional surface or 3-dimensional body comprises a mechanical component of an optical system.

27. A lithographic apparatus comprising:
a system that directs radiation to a substrate; and
a film situated within said system,
wherein said film undergoes a chemical reaction when exposed to a species, and
wherein said chemical reaction causes an alteration of a physical property of said film as an indicator of said species.

28-61. (canceled)

62. The apparatus of claim 1, further comprising:
a detector that measures a quantity of said alteration; and
a processor that determines, based on said quantity of said alteration, a quantity of said species to which said film is exposed.

63. The apparatus of claim 62,
wherein said species is embodied in an atmosphere, and
wherein said processor determines, based on said quantity of said species to which said film is exposed, a concentration of said species in said atmosphere.

64. The apparatus of claim 1, wherein said species is selected from the group consisting of a molecule, an atom, an ion, a radical and a chemical compound.

65. The apparatus of claim 1, wherein said species is selected from the group consisting of an oxide, a hydrocarbon, an O-radical, an organic compound containing sulfur and an inorganic compound containing sulfur.

66. The method of claim 16, further comprising:
measuring a quantity of said alteration; and
determining, based on said quantity of said alteration, a quantity of said species to which said film is exposed.

67. The method of claim 66,
wherein said species is embodied in an atmosphere, and
wherein said method further comprises determining, based on said quantity of said species to which said film is exposed, a concentration of said species in said atmosphere.

68. The method of claim 16, wherein said species is selected from the group consisting of a molecule, an atom, an ion, a radical and a chemical compound.

69. The method of claim 16, wherein said species is selected from the group consisting of an oxide, a hydrocarbon, an O-radical, an organic compound containing sulfur and an inorganic compound containing sulfur.

70. The lithographic apparatus of claim 27, further comprising:
a detector that measures a quantity of said alteration; and
a processor that determines, based on said quantity of said alteration, a quantity of said species to which said film is exposed.

71. The lithographic apparatus of claim 70,
wherein said species is embodied in an atmosphere, and
wherein said processor determines, based on said quantity of said species to which said film is exposed, a concentration of said species in said atmosphere.
